(19) United States
(12) Patent Application Publication
(10) Pub. No.: US 2011/0000282 A1
(43) Pub. Date: Jan. 6, 2011

(54) PASSIVE GLOVEBOX GLOVE LEAK DETECTOR

(75) Inventors: Michael E. Cournoyer, Los Alamos, NM (US); Paul J. Contreras, Rio Rancho, NM (US)

Correspondence Address: LOS ALAMOS NATIONAL SECURITY, LLC, LOS ALAMOS NATIONAL LABORATORY, PPO. BOX 1663, LC/IP, MS A187, LOS ALAMOS, NM, 87545, US

(73) Assignee: LOS ALAMOS NATIONAL SECURITY, LLC, Los Alamos, NM (US)

(21) Appl. No.: 12/496,373

(22) Filed: Jul. 1, 2009

(51) Int. Cl. G01M 3/04

(52) U.S. Cl. 73/40

(57) ABSTRACT

A passive leak detector for a glovebox glove is disclosed. Pressure drop inside the glove is measured overnight to determine if there is a leak in the glovebox glove.

### STATEMENT REGARDING FEDERAL RIGHTS

This invention was made with government support under Contract No. DE-AC52-06NA25396, awarded by the U.S. Department of Energy. The government has certain rights in the invention.

### BACKGROUND OF INVENTION

This invention relates to the field of isolation and containment of hazardous materials and sensitive materials. Numerous substances must be isolated from the atmosphere and from contact with people, yet must be accessible for manipulation by humans. These materials include radioactive substances, toxic substances, biological materials, pharmaceuticals, and electronic components such as chips. Gloveboxes are often used to contain and isolate these materials when they must be handled. These gloveboxes are completely sealed from the atmosphere and have gloves with long cuffs, or extensions, located inside the enclosure and connected to a glove port, or opening, in a wall of the enclosure. A technician inserts his hands and forearms through the port and into the cuffed gloves and then can manipulate materials and apparatus inside the box. The glovebox may be operated at either a positive or negative pressure. A small air flow through the box is usually maintained and both air entering the box and air leaving the box may pass through filters.

The gloves are the weakest link in this system. Unplanned glove openings in the glovebox environment can lead to significant costs, due to the loss in production, and the cleanup and paperwork involved. There are two main types of unplanned glove openings in the glovebox environment, glove breaches and failures. A glove failure is an opening in a glove caused by degradation of the mechanical properties over time, e.g. exposure to chemicals and nuclear materials.

Analysis of glove failures determined that some glove failures can only be detected because the pumping action of the gloves, when they are in use, causes a release of radioactive material from the glovebox. Additionally, there are other issues related to glove failures. For example, it is possible that some newly installed gloves may have holes which cannot be detected by visual inspection. It is not clear what size hole will contaminate a glovebox worker under normal working conditions.

Currently the state-of-the-art in mitigating glove failures is through a robust glove inspection program that controls the inspection and service life intervals for the gloves and commercially available glove leak detectors. Commercially available glove leak detectors test gloves in place, using pressure decay methodology. A glove plug is placed on the glove to be tested. The commercially available glove leak detectors require the glove to be pressurized for at least one minute at a pressure between 500 and 600 Pa, then only measure pressure drop over the course of four minutes.

Commercially available glove leak detectors have been found to detect a rigid hole of 100 μm in a static environment with a maximum pressure variation ±Pa and <0.05° C. temperature change. The large volume negative pressure environments found in gloveboxes used in the nuclear industry limit the detection puncture detection to 500 μm for 15 mil gloves and 1500 μm for 30 mil gloves.

### SUMMARY OF INVENTION

The present invention provides a novel improvement to glove leak detection methodology. Accordingly, the present invention provides a method and apparatus for measuring pressure drop inside the glove.

### BRIEF DESCRIPTION OF THE DRAWINGS

FIG. 1 shows the passive leak detector where no leak is detected.

FIG. 2 shows the passive leak detector where a leak is detected.

### DETAILED DESCRIPTION

In the following description, like reference characters designate like or corresponding parts throughout the several views shown in the figures. It is also understood that terms such as “top,” “bottom,” “outward,” “inward,” and the like are words of convenience and are not to be construed as limiting terms. In addition, whenever a group is described as either comprising or consisting of at least one of a group of elements and combinations thereof, it is understood that the group may comprise or consist of any number of those elements recited, either individually or in combination with each other.

Referring to the drawings in general, it will be understood that the illustrations are for the purpose of describing a particular embodiment of the invention and are not intended to limit the invention thereto.

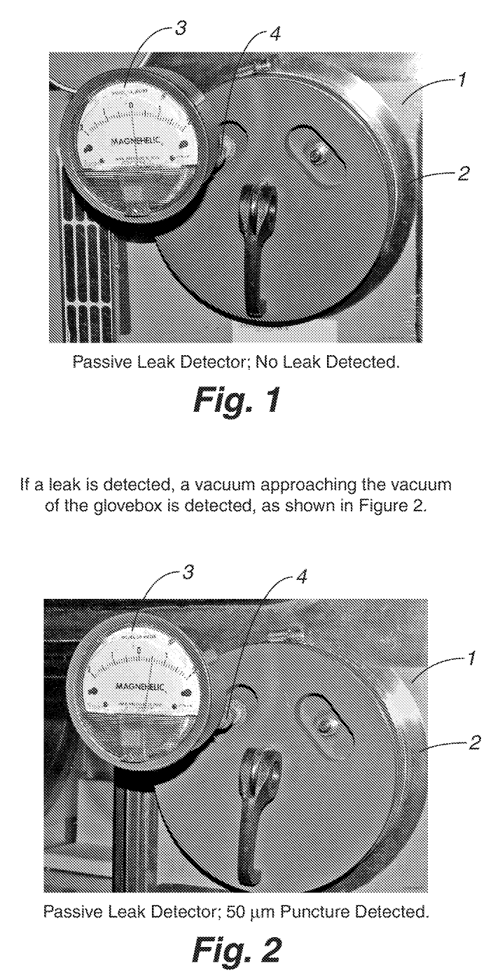

FIG. 1 shows the components of the passive leak detector. Differential pressure gauge 3 is connected to a glovebox 1. On example of a suitable differential pressure gauge is the Magnehelic Differential Pressure Gauge. However, any differential pressure gauge that can detect a vacuum from 0 to approximately 1 inch of water may be used. Glovebox 1 also has a glovebox glove plug 2 attached to close the glove opening so that there is always a barrier between the contents of the glovebox and the atmosphere. The glovebox glove plug must be able to hold a vacuum greater than approximately 1 inch of water. Additionally, a pressure relief valve 4 is attached to the glovebox as well.

In FIG. 1, as indicated by the differential pressure gauge 3, there is no vacuum detected, and therefore there is no leak in the glovebox glove. This is in contrast to FIG. 2, which shows the results of a test where the glove had a 50 μm puncture. As seen in FIG. 2, the differential pressure gauge 3 registers a reading of 0.5 inches of water. This indicates that the vacuum is approaching the vacuum inside the glovebox and therefore a leak is present in the glovebox glove. It is noted that the larger the hole in the glove, the sooner the pressure on differential pressure gauge 3 will approach the vacuum of the glovebox.

When a vacuum is detected, the passive leak detector is difficult to remove unless the vacuum inside the glovebox glove is relieved. Therefore, pressure relief valve 4 is provided. Pressure relief valve 4 relieves the vacuum inside the glovebox glove for ease of removal.

In practice, the passive leak detector is placed on a glovebox glove and left overnight. If no leak is present, no pressure drop is recorded and no vacuum is detected, as shown in FIG. 1. If a leak is detected, a pressure drop near the house vacuum is recorded and a vacuum approaching the vacuum of the glovebox is detected, as shown in FIG. 2.

The benefits of this novel approach to glovebox glove leak detection are numerous. For example:
In contrast to currently available testing methods, the glove does not have to be pressurized. A positive glove pressure increases the risk of spread of radiological contamination and excursions of contaminants into the breathing zone of any worker that may be present.
Pressure and temperature variations are not a concern using the disclosed method.
The relative pressure drop does not need to be calculated. This limits the equipment necessary. For example, a microprocessor is not necessary.
The detection limit of a puncture is reduced by a factor of 30, from 1500 μm to 50 μm.

All of these benefits will significantly reduce the number of contamination incidents and therefore the high costs incurred when there is a contamination incident. A contamination incident results in the loss of production, costs money for cleanup, and requires significant the preparation of incident documentation. It has been estimated that a contamination incident costs in to the range of $50,000 to $100,000.

The present invention is not to be limited in scope by the embodiments disclosed herein, which are intended as single illustrations of individual aspects of the invention, and any which are functionally equivalent are within the scope of the invention. Various modifications to the models and methods of the invention, in addition to those described herein, will become apparent to those skilled in the art from the foregoing description and teachings, and are similarly intended to fall within the scope of the invention. Such modifications or other embodiments can be practiced without departing from the true scope and spirit of the invention. For example, the passive leak detector disclosed herein will also work with a positive pressure glovebox, such as those commonly used in the pharmaceutical industry.

What is claimed is:

1. A method for detecting a leak in a glove of a glovebox comprising:
placing a passive leak detector consisting of a glovebox glove plug, a differential pressure gauge and a pressure relief valve on a glovebox glove;
leaving the passive leak detector on the glovebox glove overnight;
observing if there is change in pressure; and
determining if a vacuum is detected.

2. The method of claim 1, wherein the glovebox glove plug can hold a vacuum greater than 1.0 inch of water.

3. The method of claim 1, wherein the differential pressure gauge can detect a range of a vacuum from 0 to 1.0 inch of water.

4. The method of claim 1, wherein the absence of a vacuum indicates that there is no leak in the glovebox glove.

5. The method of claim 1, further comprising relieving pressure in the glovebox if a vacuum is detected.

6. An apparatus for detecting a leak in a glove of a glovebox comprising:
a glovebox glove plug;
a differential pressure gauge; and
a pressure relief valve.

7. The apparatus of claim 6, wherein the glovebox glove plug can hold a vacuum greater than 1.0 inch of water.

8. The apparatus of claim 6, wherein the differential pressure gauge can detect a range of a vacuum from 0 to 1.0 inch of water.

9. The apparatus of claim 6, wherein when the differential pressure gauge detects a vacuum approaching the vacuum of the glovebox, a leak exists in the glovebox glove.
